(19) United States
(12) Patent Application Publication
(10) Pub. No.: US 2010/0268577 A1
(43) Pub. Date: Oct. 21, 2010

(54) Systematic Social Commerce

(76) Inventor: Robert Fuggetta, San Carlos, CA (US)

Correspondence Address: CARR & FERRELL LLP, 2200 GENG ROAD, PALO ALTO, CA, 94303, US

(21) Appl. No.: 12/427,252

(22) Filed: Apr. 21, 2009

(51) Int. Cl. G06Q 30/00; G06Q 10/00

(52) U.S. Cl. 705/10; 705/14.19

(57) ABSTRACT

A platform for brand owners to identify brand advocates, mobilize the brand advocates to act on behalf of the brand, and manage and track advocate activity. A brand manager may configure a brand advocate service on a platform provided by the present system. Brand service configuration may involve configuring how a brand advocate is selected as well as configuring one or more surveys, polls, electronic cards, user rewards, and other service features for the brand advocate to utilize when promoting the brand.

### BACKGROUND

Consumer product companies must continually promote and advertise their products to consumers. Product promotion and advertising is performed with the goal of reaching current customers and prospective customer groups. Companies spend large amounts of money to promote their products to their current and potential customers in an effort to raise product awareness and entice consumers.

In addition to company driven advertising, products can be promoted by word of mouth. When a consumer is satisfied with a product, she may be inclined to recommend a product to a peer or provide a quick and informal product review. The review can be provided by the consumer on any number of websites, such as a web site of the product manufacturer or a retailer that sells the product.

Advertisers are constantly trying to improve the effectiveness of their advertising, but there is room for improvement. Newspaper, radio, television and internet advertisements reach large numbers of people, but the level of targeting available through these methods is limited. Word of mouth promotion can be a very effective form of advertisement, but companies generally have very little control of how their loyal consumer base promotes their products.

### SUMMARY OF THE INVENTION

The present technology provides a platform for brand owners to identify brand advocates, mobilize the brand advocates to act on behalf of the brand, and manage and track advocate activity. A brand manager may configure a brand advocate service on a platform provided by the present system. Brand service configuration may involve configuring how a brand advocate is selected as well as configuring one or more surveys, polls, electronic cards, user rewards, and other service features for the brand advocate to utilize when promoting the brand.

An embodiment can receive a first data by a server associated with a brand from a first user at a client device. The first user is identified as a brand advocate by the server based on the first data. Brand data is electronically transmitted by the server to a recipient identified by the brand advocate. The brand advocate data associated with the transmitted brand data to memory by the server is stored.

Embodiments of the present technology may further include systems and computer-readable storage media. Such systems can perform methods associated with systematically socializing commerce and managing brand advocacy. The computer-readable media has programs embodied thereon. The programs may be executed by a processor to perform methods associated with systematically socializing commerce and managing brand advocacy.

### BRIEF DESCRIPTION OF THE DRAWINGS

FIG. 1A is an environment for providing a brand advocate system.

FIG. 1B is an exemplary embodiment of a brand advocate application.

FIG. 2 is a flow chart of an exemplary method for providing a brand advocate service.

FIG. 3 is a flow chart of an exemplary method for configuring a brand advocate service.

FIG. 4 is an exemplary process map for configuring a brand advocate service.

FIG. 5 is a flow chart of an exemplary method for identifying a user as a brand advocate.

FIG. 6 is a flow chart of an exemplary method for promoting a brand by a brand advocate.

FIG. 7 is an exemplary process map for promoting a brand through a brand advocacy service.

FIG. 8 is a block diagram illustrating interactions of an exemplary brand advocate community.

FIG. 9 is a flow chart of an exemplary method for publishing a review by a brand advocate service.

FIG. 10 is a block diagram of an exemplary computing device for implementing the present technology.

### DETAILED DESCRIPTION OF EXEMPLARY EMBODIMENTS

The present technology provides a platform for brand owners to identify brand advocates, mobilize the brand advocates to act on behalf of the brand, and manage and track advocate activity. A brand manager may configure a brand advocate service on a platform provided by the present system. Brand service configuration may involve configuring how a brand advocate is selected as well as configuring one or more surveys, polls, electronic cards, user rewards, and other service features for the brand advocate to utilize when promoting the brand.

A brand advocate can be a user who has indicated a preference for a particular brand. The user's preference or passion for a brand may be determined from information received by the brand advocate service. For example, a user (e.g., a potential brand advocate) may complete a survey with respect to a brand and submit the survey to the brand advocacy service. If the survey results indicate that the user is a supporter and/or has a preference for the brand, the brand manager can invite the user to be a brand advocate within the brand advocate service.

Once identified as a brand advocate, a user may configure an account, create content, and mobilize or promote the brand through the brand advocate service. Mobilization and promotion may include recruiting additional brand advocates, disbursing positive information regarding a brand, and otherwise increasing the reputation and visibility of a brand through actions coordinated by the brand advocacy service. A brand advocate and the advocacy process is tracked and stored by the brand advocacy system.

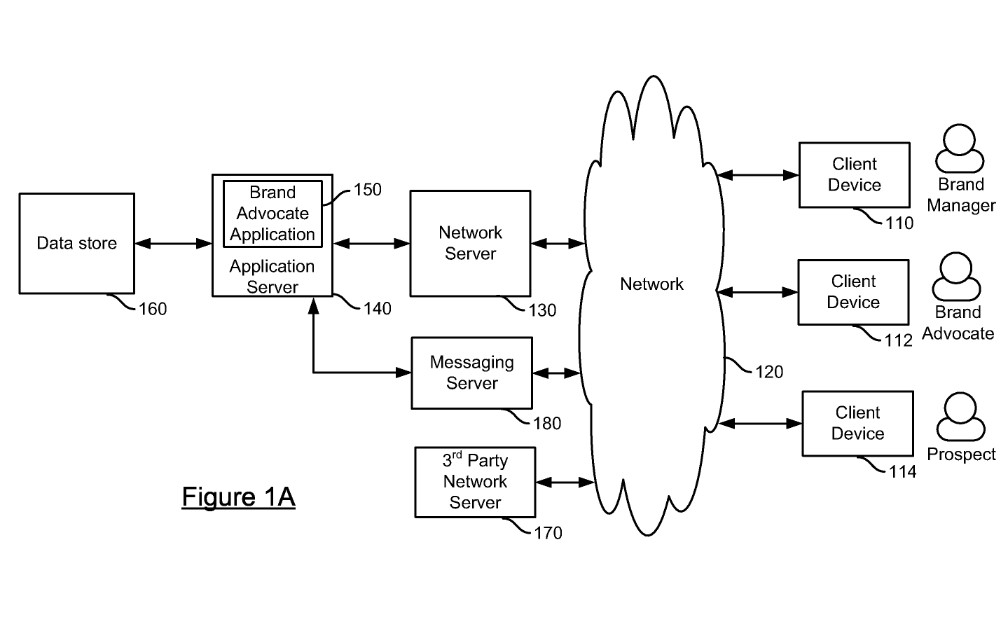

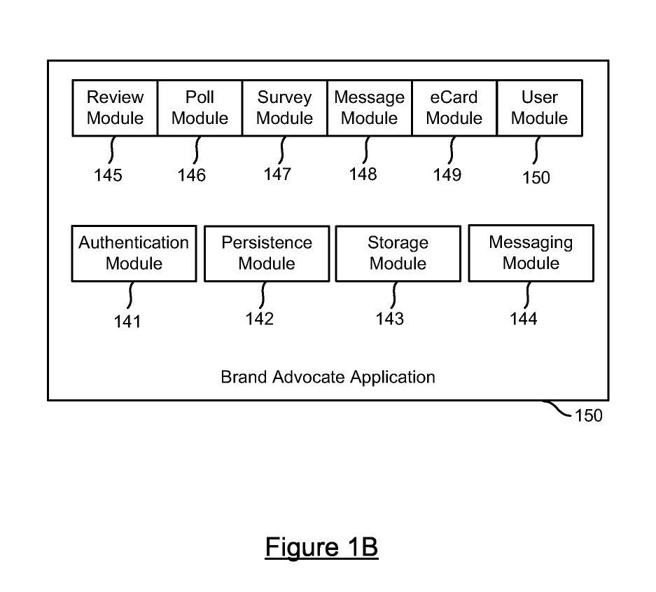

FIG. 1A is an environment for providing a brand advocate system. FIG. 1A includes client devices 110, 112 and 114 connected to network 120. Network 120 is also connected to network server 130, third party server 170, and messaging server 180.

Client devices 110, 112 and 114 may be implemented as computing devices such as workstations, servers, lap top computers, mobile devices, or other computing devices that can communicate over network 120. Client devices 110, 112 and 114 may each include a browser application for rendering brand advocate service interface data as a web page interface. For example, a browser application on client 110 may render brand advocate service interface data for configuring and managing a brand advocate service, and a browser application on client 112 may render brand advocate service interface data for participating in a brand advocate service as a brand advocate and promoting a brand. Client device 110 can be associated with a brand manager that configures a brand advocate service. Client device 112 can be associated with a brand advocate that is selected based on an opinion of a brand. Client device 114 can be associated with a prospect. The prospect may be a potential brand advocate who receives information from brand advocate 112 through application server 150.

Network 140 is inclusive of any communication network such as the Internet, Wide Area Network (WAN), Local Area Network (LAN), intranet, extranet, private network, public network, some combination of these networks, or other network.

Network servers 130 and 170 and messaging server 180 are connected to and may communicate over network 120. Network server 130 may receive requests for and send responses on behalf of application server 150 over network 120. In some embodiments, network server 130 may be implemented as a web server when network 120 is implemented as the Internet.

Messaging server 180 may include one or more servers configured to send electronic messages, surveys, polls, e-cards, notifications, and other electronic data over network 120 to clients 110, 112, and 114. Transmission of message data by messaging server 180 may be initiated by application server 150. Each of network servers 130 and 180 can be implemented as one or more servers. The data may be sent to potential brand advocate 112, a prospect 114, or a brand manager 110 on behalf of application server 140.

Third party network server 170 may serve as a portal for a third party electronic commerce service, a networking service, or some other service. In some embodiments, third party network server 170 may serve as a web server which provides brand reviews, brand bulletin boards, or other content associated with a brand that may be posted by brand advocate application 150. Brand advocate application 150 may submit brand information to third party network server as part of a submission made through a user account with the third party network service.

Application server 150 may be implemented in a general computing device that otherwise communicates with data store 160, network server 130 and messaging server 180. Application server 150 can also communicate with third party network server 170. Application server 120 as illustrated in FIG. 1 includes brand advocate application 150. Brand advocate application 150 may be stored in memory and executed by a processor to identify brand advocates, mobilize and allow brand advocates to promote a brand on behalf of a brand manager, and track brand advocate activity. The brand advocate application 150 may receive data to configure a brand advocate service by a brand manager and data to participate in a brand advocate service by a brand advocate.

Data store 160 may be implemented as one or more physical or logical servers for storing brand advocate data, brand manager data, and brand advocate service data. Date store 160 may be accessed by application server 140.

FIG. 1B is an exemplary embodiment of a brand advocate application 150. Brand advocate application 150 includes a number of modules which may be implemented as software stored in memory on application server 140 and executed by a processor.

Various modules can form part of an application layer of brand advocacy application 150 and are executed to allow a brand manager to configure the brand advocate service and a brand advocate to promote the brand. The executable modules, as illustrated in FIG. 1B, include review module 145, poll module 146, survey module 147, message module 148, and e-card module 149. Review module 145, when executed by a processor, enables a brand manager to manage brand advocate authored reviews by suspending, rejecting, deleting or approving reviews. The review module may also enable a brand advocate to generate, edit, and submit reviews to the brand advocate service as well as a third party network server.

Poll module 146 can be executed to allow a brand manager create a new poll, delete a poll, send a poll to a recipient (e.g., as an email message to a brand advocate), activate or deactivate a poll on a particular web page provided by application server 140 through network server 130, and view and edit a poll.

Survey module 147 can be executed to create, delete, send, view and edit qualification surveys used to determine whether a survey recipient can be a brand advocate. Survey module can also be executed to access and transmit surveys in response to a request from a prospective brand advocate.

Message module 148 may be executed to create, edit and submit messages such as email messages on behalf of the brand advocate and allow the brand advocate to manage a message inbox.

E-card module 149 may be executed to allow a brand advocate to browse and submit one or more e-cards to a particular recipient. The e-card may present information about a particular brand and invite the recipient to take a survey for the brand.

User module 150 can be executed to allow a brand advocate to configure a profile for a brand advocate service. The profile may include the brand advocate name, an image, rating information for one or more brands, tracking information for the polls, surveys, messages and e-cards the user has sent or engaged in, and other data.

Some software modules of brand advocate application 150 can form an interface layer to manage communication and other operations. Interface layer applications include authentication module 141, persistence module 142, storage module 143 and messaging module 144. Authentication module 141 may be executed to handle the login process for a brand manager and brand advocate. The authentication module 141 can retrieve authentication data from local memory or data store 160 for the person attempting to login, compare retrieved authentication data with authentication data received from a user, and authenticate the user based on whether the two sets of authentication data match.

Persistence module 142 may be executed to cache various data associated with the brand advocate service locally to application server 140 or application servers comprising application server 140. Caching data locally provides for quick access to data (e.g., when compared to accessing the data from a remote data store or other server) and improves performance of the brand advocate service.

Storage module 143 may be executed communicate with data store 160 to store, update, delete and create data associated with a brand advocate, a brand manager, and brand advocate service. The data may include data associated with modules 145-150 as well as other data.

Messaging module 144 may be executed to transmit and receive message data to a destination on behalf of a brand advocate or brand manager. For example, messaging module 144 may receive a message from message module 148, wrap the message in the appropriate envelope format for transmission, and send transmit the message data in the form of an e-card, message, poll entry or some other format.

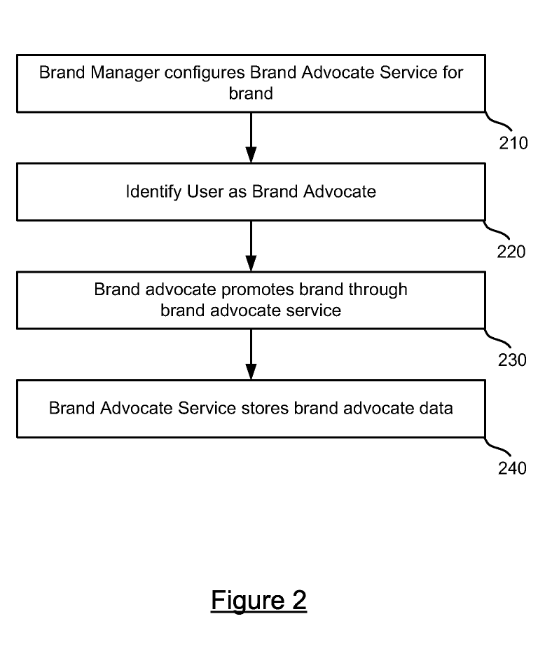

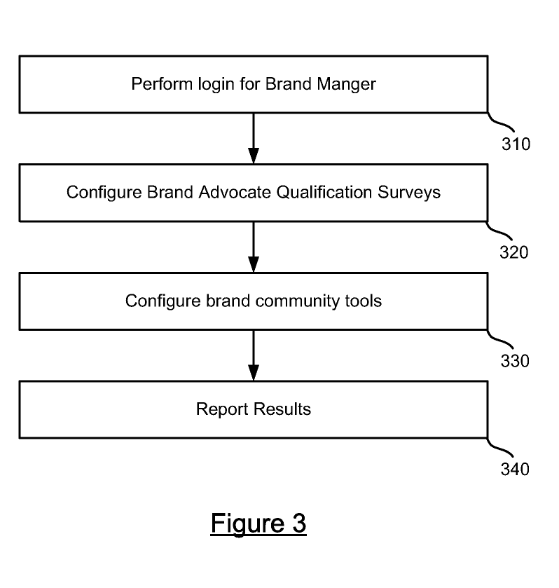

FIG. 2 is a flow chart of an exemplary method for providing a brand advocate service. The method of FIG. 2 can be implemented by brand advocate application 150 stored in memory and executed by a processor on application server 140. A brand manager configures a brand advocate service for a brand at step 210. The brand manager may configure the brand advocate service through interfaces provided by application server 150 to client device 110. Configuring the brand advocate service may include configuring surveys, tools, reports and other features of the service. Configuring a brand advocate service for a brand is discussed in more detail below with respect to FIG. 3.

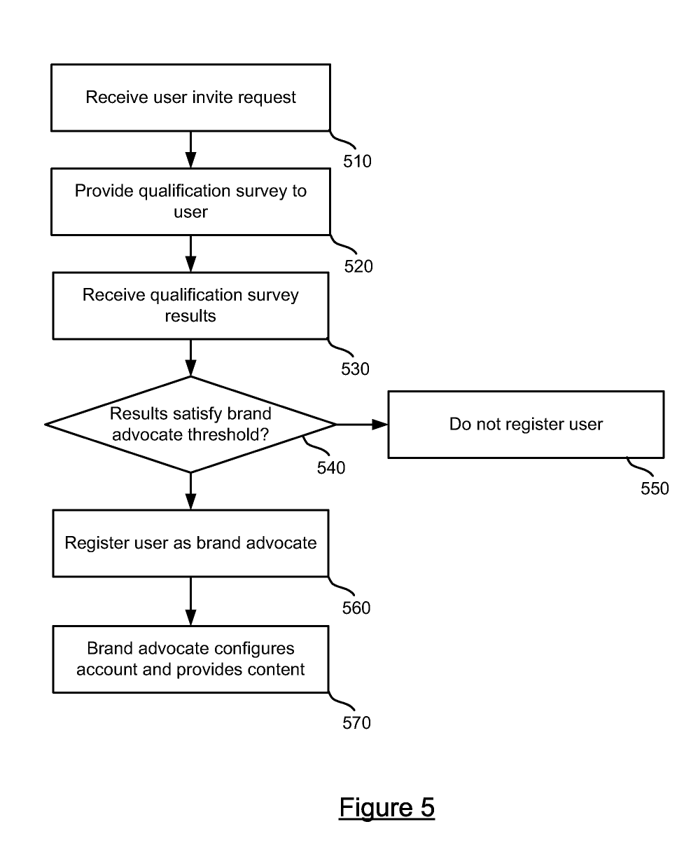

A user can be identified as a brand advocate at step 220. If a user meets certain criteria, for example is determined to be likely to recommend a particular brand, the user can be identified as a brand advocate. Identifying a user as a brand advocate is discussed in more detail below with respect to FIG. 5.

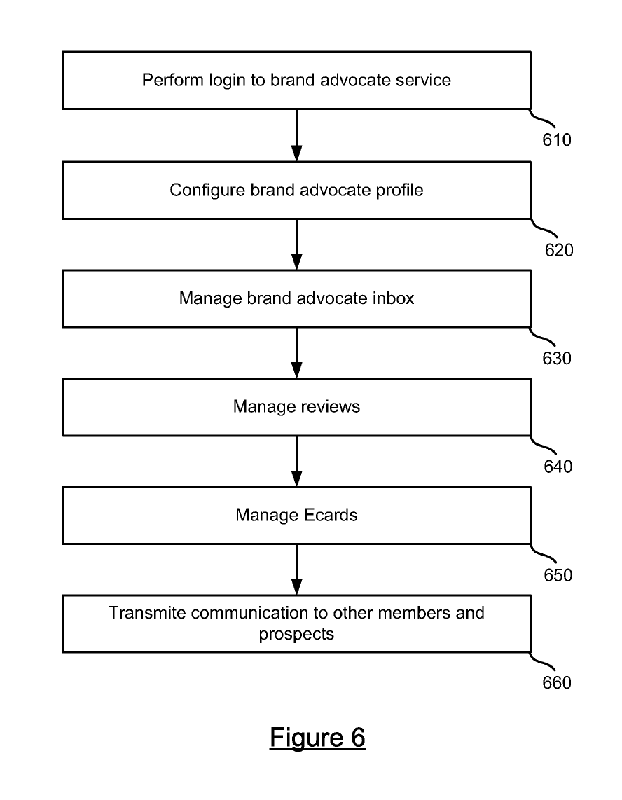

A brand advocate may promote a brand through the brand advocate service at step 230. Promoting a brand may include crating and submitting reviews, sending messages and e-cards, participating in polls, and performing other actions through the brand advocate service. These actions will promote the brand and increase the visibility of the brand to other potential consumers. The user may be rewarded points or other rewards for promotion of the brand, wherein the points may be redeemable for coupons and other rewards through the brand advocate service. Promoting a brand through a brand advocate service is discussed in more detail below with respect to FIG. 6.

The brand advocate service can store brand advocate data at step 240. The data can be stored at application server 140 or in data store 160. In some embodiments, the data may be stored in groups or “buckets” per user per brand, or in other groups. For example, the data may be stored per user and separated by category, brand, geographical area, and in some other manner.

FIG. 3 is a flow chart of an exemplary method for configuring a brand advocate service. In some embodiments, the method of FIG. 3 provides more detail for step 210 of the method of FIG. 2. A login is performed for a brand manager at step 310. A brand manager provides a user name and password through client device 110 to application service 140. The brand advocate application 150 receives the user name and password, authenticates the user name password against previously stored username and password authentication data, and completes login for the brand manager if the authentication is successful (e.g., if the received username and password match the previously stored username and password)

A brand advocate qualification survey is configured at step 320. The survey may be used to identify a brand advocate through a series of questions or other input collected through the survey. In some embodiments, the user is selected to be a brand advocate for a brand if the user is at least 70% likely to recommend that brand. In some embodiments, a brand manager can configure brand advocate qualification survey with respect to who can receive the survey, when the survey may be sent to prospects, when the surveys are available through 3^{rd} party websites, and other information.

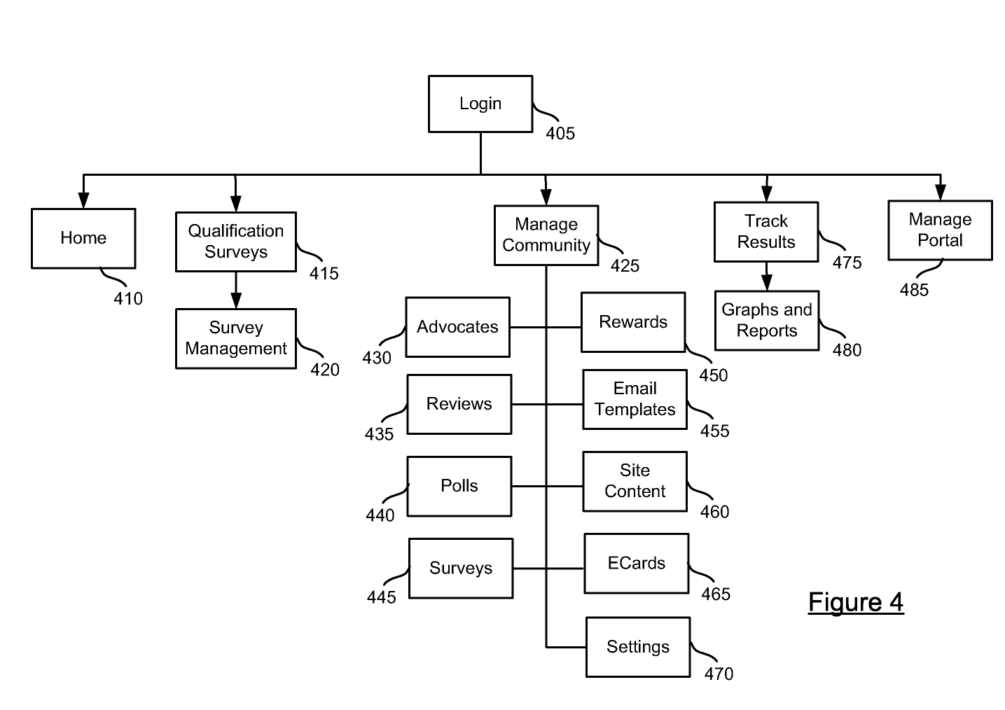

Brand community tools are then configured by a brand manager at step 330. The community tools may be configured to allow a user to promote, increase the visibility, or help identify potential brand advocates for a brand (“mobilize”). The tools may include polls, reviews, electronic cards, messages, and other tools used to promote the brand. Configuring brand community tools is discussed in more detail below with respect to the process map of FIG. 4.

Results are then reported at step 340. Results can be reported through a graph, chart, list, or in some other manner. The reports may be provided as a number of brand advocates associated with a brand, the tools used by those brand advocates, the prospects contacted, the prospects which responded and became brand advocates, location of brand advocates, and any other data collected by the brand advocate service.

FIG. 4 is an exemplary process map for configuring a brand advocate service. In some embodiments, the process map of FIG. 4 is associated with the method of FIG. 3. The process map indicates how a brand manager may navigate, in the example of FIG. 4, a series of interfaces or “pages” to configure a brand advocate service. The navigation may include providing interface data to client 110 by application server 140 and rendering the data at client 110. FIG. 4 indicates that after a login page 405, a user may navigate to either a home page 410, a survey qualification page 415, a community management page 425, a result tracking page 475 or a portal management page 485. If a user navigates to the survey qualification page, the brand manager may then manage surveys at page 420. Similarly, a brand manager may obtain graphs and reports upon navigating to graphs and reports page 480 from track results page 475.

A user may earn rewards by identifying a reward for each brand advocate promotional activity performed, the type of reward, and how the reward can be redeemed. The reward data may be configured and accessed when the brand manager executes rewards module 450.

FIG. 5 is a flow chart of an exemplary method for identifying a user as a brand advocate. In some embodiments, the method of FIG. 5 provides more detail for step 220 of the method of FIG. 2 and is implemented by brand advocate application., The brand advocate service receives a user request, as illustrated in FIG. 5, at step 510. A user may submit the request by selecting a link from a third party site, a brand manager site, or some other location. In response to the request, a qualification survey is transmitted to the user at step 520. Qualification survey results may then be received at step 530. The results will include data answering user questions presented in the survey.

A determination can be made as to whether the results received satisfy a brand advocate threshold at step 540. In some embodiments, the results may satisfy the brand advocate threshold if the results indicate that the user is 70% likely to positively recommend a particular brand. If the results do not satisfy the brand advocate threshold, the user is not selected and registered as a brand advocate at step 550.

If the results satisfy the brand advocate threshold, the user can be registered as a brand advocate at step 560. As part of the registration, a user may receive a user name, password, and a profile may be created for the user by brand advocate application 150. The brand advocate may then configure the account and provide content to brand advocate application 150 at step 570. This is discussed in more detail below with respect to FIG. 6.

FIG. 6 is a flow chart of an exemplary method for promoting a brand by a brand advocate. The method of FIG. 6 provides more detail for step 570 of the method of FIG. 5 and can occur after the brand has been registered. A brand advocate performs login to a brand advocate service at step 610. Performing login may include receiving the user's user name and password and authenticating the username and password against previously stored username and password. A brand advocate profile is then configured at step 620. Configuring the brand advocate profile may include receiving a user name, preferences, a photo, avatar, geographical information, and other data from the brand advocate. Additionally, a brand advocate may change the existing profile data.

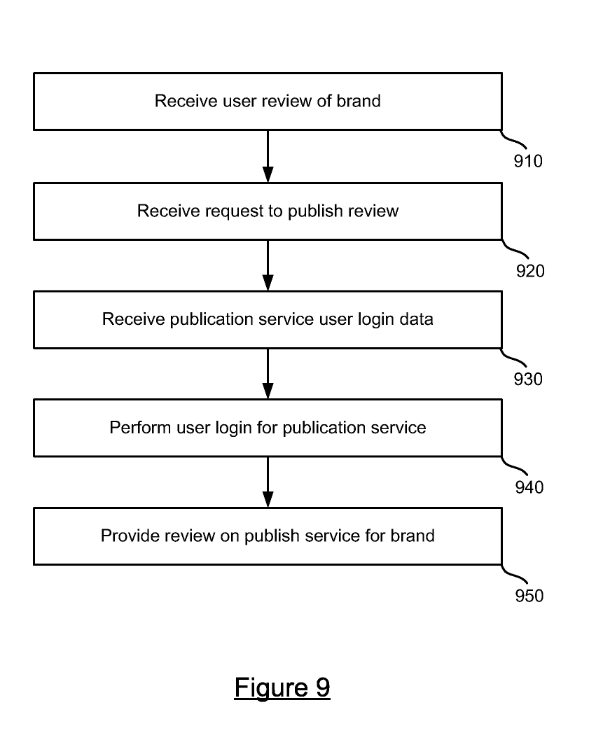

A brand advocate inbox can be managed at step 630. Managing the brand advocate inbox may include creating messages, reading messages, deleting messages, and sending messages to other brand advocates, prospects, or a brand manager. Reviews may then be managed at step 640. Managing reviews may include creating a review, posting a review in the brand advocate community, submitting a review to a third party network service, or editing a review. Managing reviews is discussed in more detail below with respect to the method of FIG. 9. E-cards may be managed at step 650. Managing an e-card may include browsing a list of e-cards, personalizing a selected e-card and transmitting a personalized e-card to a prospect associated with client device 113.

A message may be sent to other members of the advocacy service and prospects for the service at step 660. Sending a message to another member or prospect may include transmitting a message to a member bulletin board, nominating a prospect to be a brand advocate, or performing some other action.

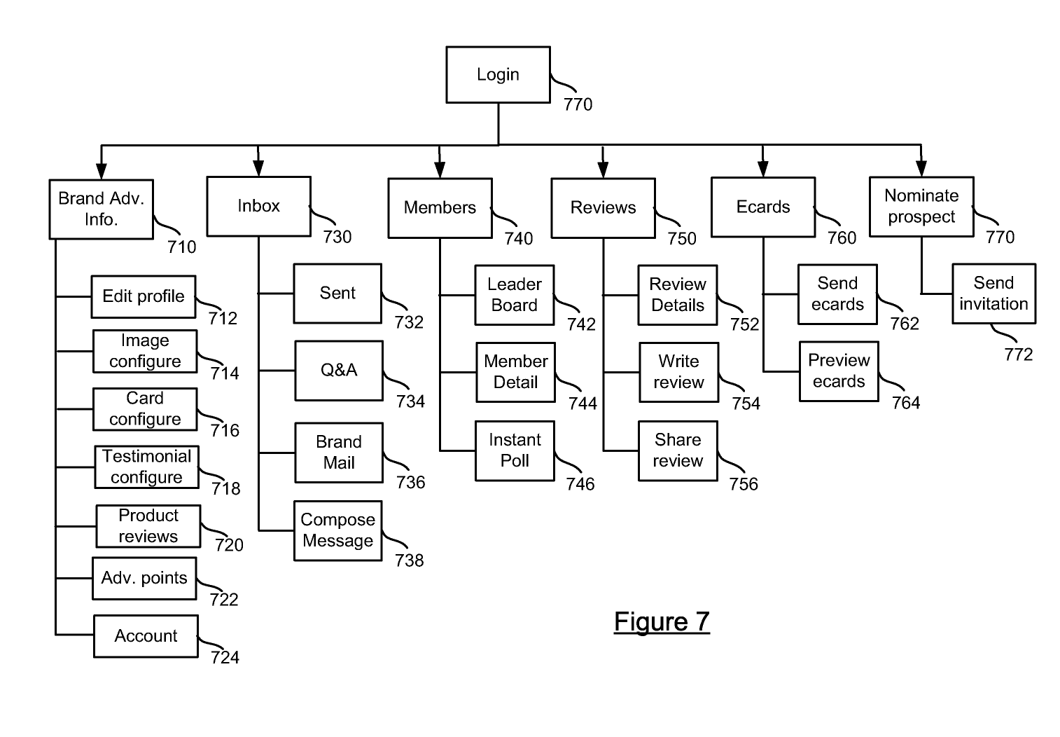

FIG. 7 is an exemplary process map for promoting a brand through a brand advocacy service. In some embodiments, the process map is associated with the method of FIG. 6. The process map includes a first step of a login 770. The process may then continue to any of a number of interfaces, such as a brand advocate informational interface, inbox interface, a members interface, reviews interface, e-cards interface, or a nominate prospect interface. The brand advocate informational interface may be used to navigate in such a manner as to edit a brand advocate profile, configure an image, configure a card, configure a testimonial, review a product, issue points, or otherwise manage an account. The user may navigate an inbox interface to send email, participate in question and answer bulletin board threads, send mail within the brand advocate community, or compose a message to other persons outside the brand advocate community, such as prospects associated with client device 114.

A brand advocate may navigate through interfaces provided by brand advocate application to client device 110 to provide member data through a leader board, member detail, or an instant poll. The brand advocate may also navigate to provide review details, write a review, or share a review through review interface 750. E-cards may be sent or previewed by a user through interface 760. A prospect may be nominated through interface 770.

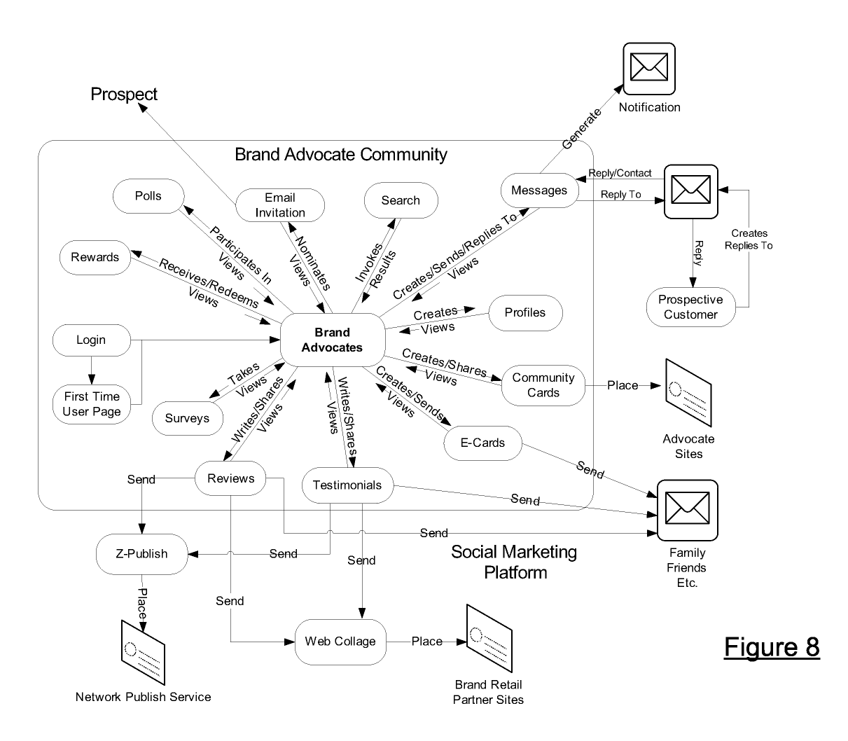

FIG. 8 is a block diagram of an interaction of an exemplary brand advocate community. The block diagram of FIG. 8 illustrates a brand advocate and a number of interactions or promotional activities which may be performed by the brand advocate. For example, after the brand advocate performs a login, the brand advocate may take a survey. After taking the survey, the brand advocate may view the survey. The brand advocate may also write or share reviews and view the reviews subsequently. The brand advocate may write or share testimonials, community cards, email locations, and polls. Each of these may also be viewed by the user after they are created. A search may be invoked by the user to determine more information about a particular aspect of a brand advocate community. Results are then provided by a search engine to the brand advocate.

FIG. 9 is a flow chart of an exemplary method for publishing a review by a brand advocate service. In some embodiments, the method of FIG. 9 provides more detail for step 640 of the method of FIG. 6. Brand advocate application 150, stored in memory and executable by a processor on application server 140, can be executed to perform the method of FIG. 9. First, a brand advocate review of a brand is received at step 910. A request to publish the review may be received at step 920. The brand advocate may select to publish and the destination at which to publish the review. The brand advocate service may then contact the destination and publish the review according to the user's input. The destination may be a retail site, a social networking site, a review site, or some other network service. Publication services or login data is received at step 930 and a user login is performed for the publication service at step 940. The review is then provided on the public service for the brand at step 950. The review is posted on the service for the particular product.

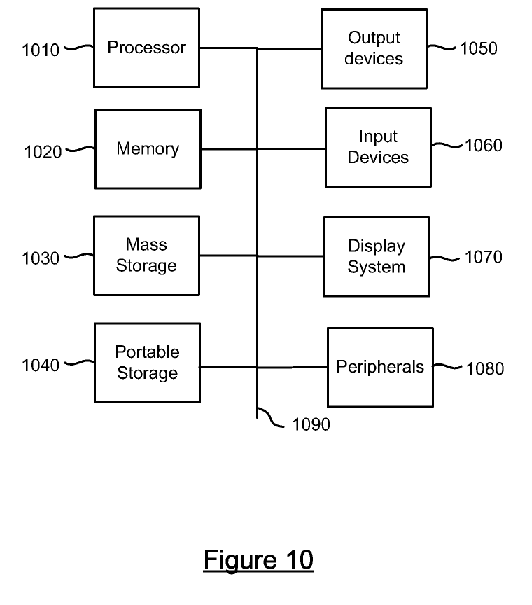

FIG. 10 illustrates an exemplary computing system 1000 that may be used to implement an embodiment of the present invention. System 1000 of FIG. 10 may be implemented in the contexts of the likes of data store 160, application server 140, network server 130, and clients 110-114. The computing system 1000 of FIG. 10 includes one or more processors 1010 and memory 1010. Main memory 1010 stores, in part, instructions and data for execution by processor 1010. Main memory 1010 can store the executable code when in operation. The system 1000 of FIG. 10 further includes a mass storage device 1030, portable storage medium drive(s) 1040, output devices 1050, user input devices 1060, a graphics display 1070, and peripheral devices 1080.

The components shown in FIG. 10 are depicted as being connected via a single bus 1090. However, the components may be connected through one or more data transport means. For example, processor unit 1010 and main memory 1010 may be connected via a local microprocessor bus, and the mass storage device 1030, peripheral device(s) 1080, portable storage device 1040, and display system 1070 may be connected via one or more input/output (I/O) buses.

Mass storage device 1030, which may be implemented with a magnetic disk drive or an optical disk drive, is a non-volatile storage device for storing data and instructions for use by processor unit 1010. Mass storage device 1030 can store the system software for implementing embodiments of the present invention for purposes of loading that software into main memory 1010.

Portable storage device 1040 operates in conjunction with a portable non-volatile storage medium, such as a floppy disk, compact disk or Digital video disc, to input and output data and code to and from the computer system 1000 of FIG. 10. The system software for implementing embodiments of the present invention may be stored on such a portable medium and input to the computer system 1000 via the portable storage device 1040.

Input devices 1060 provide a portion of a user interface. Input devices 1060 may include an alpha-numeric keypad, such as a keyboard, for inputting alpha-numeric and other information, or a pointing device, such as a mouse, a trackball, stylus, or cursor direction keys. Additionally, the system 1000 as shown in FIG. 10 includes output devices 1050. Examples of suitable output devices include speakers, printers, network interfaces, and monitors.

Display system 1070 may include a liquid crystal display (LCD) or other suitable display device. Display system 1070 receives textual and graphical information, and processes the information for output to the display device.

Peripherals 1080 may include any type of computer support device to add additional functionality to the computer system. For example, peripheral device(s) 1080 may include a modem or a router.

The components contained in the computer system 1000 of FIG. 10 are those typically found in computer systems that may be suitable for use with embodiments of the present invention and are intended to represent a broad category of such computer components that are well known in the art. Thus, the computer system 1000 of FIG. 10 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method for managing brand advocacy, comprising:
receiving a first data by a server associated with a brand from a first user at a client device;
identifying the first user as a brand advocate by the server based on the first data;
electronically transmitting brand data by the server to a recipient identified by the brand advocate; and
storing brand advocate data associated with the transmitted brand data to memory by the server.

2. The method of claim 1, wherein the first data includes survey data.

3. The method of claim 1, further comprising identifying the first user as an advocate based on a ranking of the brand by the first user.

4. The method of claim 1, wherein identifying the first user includes registering the user with a brand advocacy service associated with the server.

5. The method of claim 1, wherein the electronic destination includes an email address.

6. The method of claim 1, wherein the electronic destination includes an electronic commerce service page.

7. The method of claim 1, wherein the brand information includes a review.

8. The method of claim 1, wherein the brand information includes an electronic card.

9. The method of claim 1, wherein the brand information includes an offer.

10. The method of claim 1, wherein the results includes a rating for the brand, the rating provided by an electronic commerce service.

11. The method of claim 1, wherein the results indicate a number of users which register with a brand advocacy service.

12. The method of claim 1, wherein the results are stored to a remote data store by the server.

13. One or more processor readable storage devices having processor readable code embodied on said processor readable storage devices, said processor readable code for programming one or more processors to perform a method comprising:
receiving a first data by a server associated with a brand from a first user at a client device;
identifying the first user as a brand advocate by the server based on the first data;
electronically transmitting brand data by the server to a recipient identified by the brand advocate; and
storing brand advocate data associated with the transmitted brand data to memory by the server.

14. The one or more processor readable storage devices of claim 13, wherein the first data includes survey data.

15. The one or more processor readable storage devices of claim 13, further comprising identifying the first user as an advocate based on a ranking of the brand by the first user.

16. The one or more processor readable storage devices of claim 13, wherein identifying the first user includes registering the user with a brand advocacy service associated with the server.

17. The one or more processor readable storage devices of claim 13, wherein the electronic destination includes an email address.

18. The one or more processor readable storage devices of claim 13, wherein the electronic destination includes an electronic commerce service page.

19. The one or more processor readable storage devices of claim 13, wherein the brand information includes a review.

20. The one or more processor readable storage devices of claim 13, wherein the brand information includes an electronic card.

21. The one or more processor readable storage devices of claim 13, wherein the brand information includes an offer.

22. A method for managing brand advocacy, comprising:
receiving a request from a brand advocate to transmit brand data from a server to a recipient;
electronically transmitting brand data from the server to the recipient identified by the brand advocate; and
receiving response data from the recipient in response to the transmitted brand data; and
storing the response data in association with the brand advocate in memory.

23. The method of claim 1, further comprising providing the brand advocate with a non-tangible reward.
